(19) United States
(12) Patent Application Publication
(10) Pub. No.: US 2026/0160122 A1
(43) Pub. Date: Jun. 11, 2026

(54) WATER RETAINING WINDOW

(71) Applicant: Zhejiang Dongrui Industrial and Trading Co., Ltd., Jinhua City (CN)

(72) Inventor: Feihong XU, Jinhua City (CN)

(21) Appl. No.: 19/030,485

(22) Filed: Jan. 17, 2025

(30) Foreign Application Priority Data
Dec. 6, 2024 (CN) 2024230099778

(51) Int. Cl. E06B 7/14

(52) U.S. Cl. CPC E06B 7/14

(57) ABSTRACT

The disclosure provides a water retaining window, and relates to related technical field of aluminum alloy windows. The water retaining window includes an outer window and an inner window member. A drainage groove is provided between the outer window and the inner window member, a water retaining member is fixedly installed in the drainage groove at both sides, and the outer window is connected with a flow guide structure at the drainage groove at an upper side. In the disclosure, water at an edge of the window is guided to flow with the simple water retaining member, so that continuous contact between the window and the water is reduced, thus realizing drainage effect. The flow guide part of the water retaining member contacts with the water flowing down, which moves through an inclined plane and flows out of the drainage groove of the window to realize the drainage effect.

### TECHNICAL FIELD

The disclosure relates to related technical field of aluminum alloy windows, in particular to a water retaining window.

### BACKGROUND ART

At existing construction sites, in order to meet needs of temporary housing, sheet iron houses are usually scheduled to be assembled to meet housing and storage needs of workers. However, during assembly and use, the sheet iron houses have a concave-convex structure, and gaps may exist at joints between windows and the sheet iron houses. When the rain is too heavy, a large amount of rain easily seeps in from the joints of the window.

For existing windows, rubber seals may be added to reduce possibility of water seepage, but water already flowing in is still untreated, which is easy to soak and damage window connectors.

### SUMMARY

Object: an object of the disclosure is to provide a water retaining window, which solves a problem of seepage damage at a joint of a window caused by constant contact between water seeped at the window and the window.

### Solution

A water retaining window includes an outer window and an inner window member. A drainage groove is provided between the outer window and the inner window member, a water retaining member is fixedly installed in the drainage groove at both sides which are opposite, and the outer window is connected with a flow guide structure at the drainage groove at an upper side.

Preferably, the drainage groove is arranged on a peripheral side of the outer window.

Preferably, the water retaining member includes a main part, an upper side of the main part is connected with a flow guide part which is obliquely arranged, a side wall of the main part is provided with a connecting part for fixing, and a flow guide cavity is formed among the connecting part, the flow guide part and the main part.

Preferably, the water retaining member is respectively provided at upper and lower ends of the drainage groove, upper and lower water retaining members are oppositely arranged, opening directions of two flow guide cavities are opposite, the connecting part is fixedly connected with a side wall of the drainage groove, and the main part is abutted against an inner wall of the drainage groove.

Preferably, the flow guide structure includes a barrier bar, the barrier bar is fixedly connected with the side wall of the drainage groove, the barrier bar extends upward out of the drainage groove, and an inclined bar is fixedly connected below the barrier bar in the drainage groove.

Preferably, the outer window and the inner window member are located on inner and outer sides of a wall respectively.

Preferably, a gap is remained between the flow guide part and the connection part.

Preferably, the connecting part is provided with a through connecting hole.

Beneficial effects: water at an edge of the window is guided to flow with the simple water retaining member, so that continuous contact between the window and the water is reduced, thus realizing drainage effect. The flow guide part of the water retaining member contacts with the water flowing down, which moves through an inclined plane and flows out of the drainage groove of the window to realize the drainage effect.

### BRIEF DESCRIPTION OF THE DRAWINGS

FIG. 1 is a schematic view of an overall structure according to the disclosure;

FIG. 2 is a schematic structural side view according to the disclosure;

FIG. 3 is a schematic view of a window installation structure according to the disclosure;

FIG. 4 is a schematic side view of a wall according to the disclosure;

FIG. 5 is an enlarged schematic structural view at A in FIG. 4;

FIG. 6 is a schematic structural view of a window according to the disclosure;

FIG. 7 is a schematic view of a flow guide structure according to another embodiment; and

FIG. 8 is a schematic view of installation of a water retaining member.

Reference numerals: 11. Water Retaining Member; 12. Main Parts 13. Flow Guide Part; 14. Connecting Part; 15. Through Hole; 16. Gap; 21. External Window; 22. Inner Window Member; 23. Drainage Groove; 24. Barrier Bar; 25. Inclined Bar; 31. Wall; 32. Aluminum Groove.

### DETAILED DESCRIPTION

In order to make technical schemes of the disclosure more clear, the disclosure will be further explained in detail in the following in combination with drawings and specific examples.

### Embodiment 1

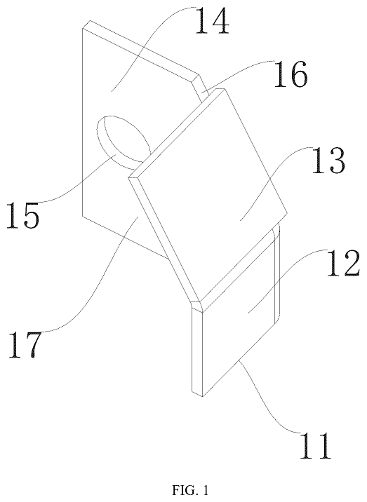

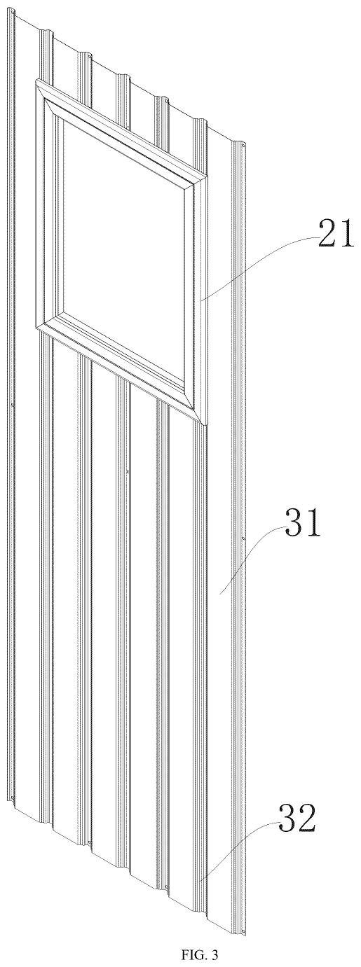

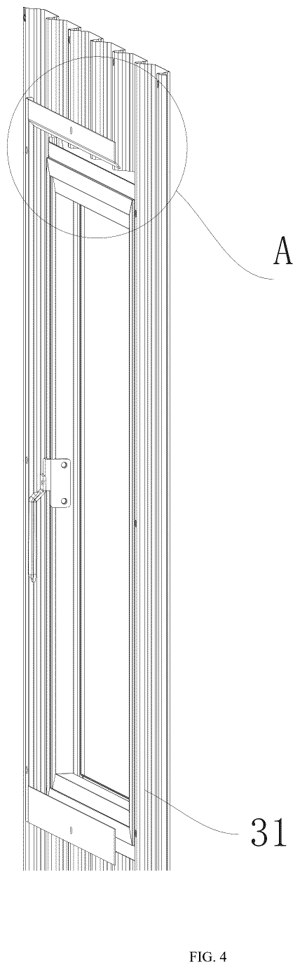

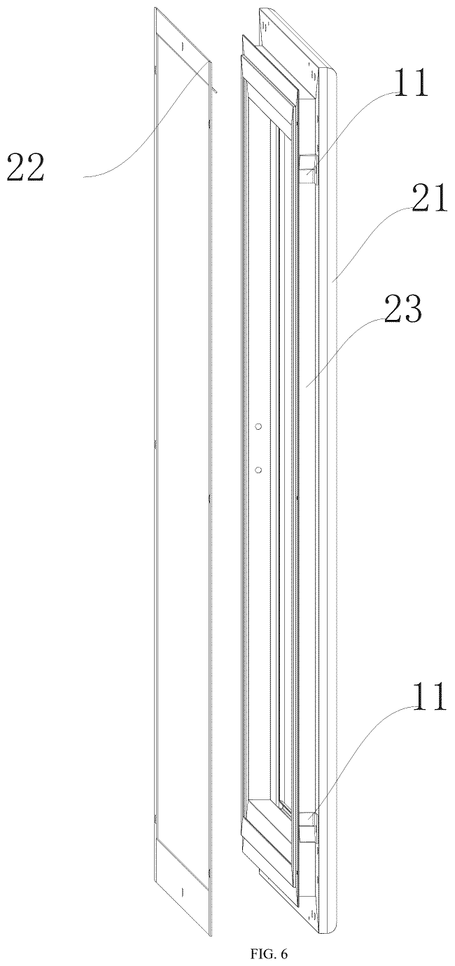

As shown in FIGS. 1 to 6, a water retaining member is provided, the water retaining member 11 is connected with a window, and the window is connected with a wall 31.

The window includes an outer window 21 and an inner window member 22. The inner window member 22 is installed on an inner side of the wall 31. The outer window 21 and the inner window member 22 are fixedly connected with each other, and a drainage groove 23 is arranged on a peripheral side of the outer window 21, and the water retaining member 11 is fixedly connected with the drainage groove 23. The outer window 21 and the inner window member 22 can be buckled to each other or connected by screws or other connectors.

When the window is in use, the window is installed on the wall 31, and the aluminum wall 31 is generally provided with a plurality of aluminum grooves 32 recessed into the wall arranged at intervals. The aluminum grooves 32 are prone to water leakage, and the window is provided with a flow guide structure on an upper end of the window to ensure that leaking water does not seep into the house. The flow guide structure is arranged on an inner side of the wall, and a lower end of the flow guide structure is proximate to the inner window member 22. seeped water from the inner side of the wall may contact the flow guide structure and then flow into the drainage groove 23 without flowing all the way to the inner side of the wall 31.

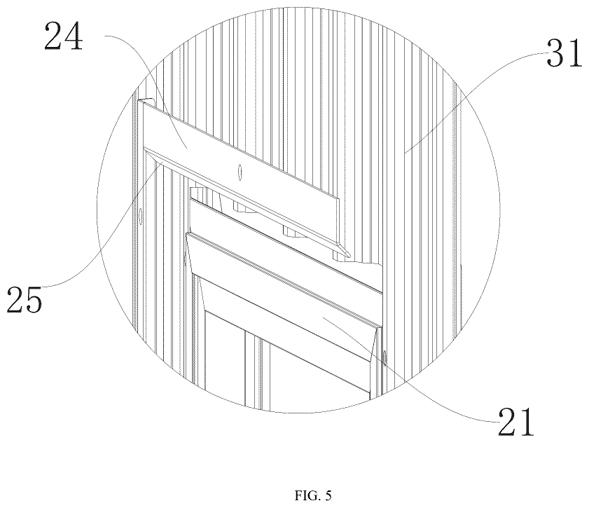

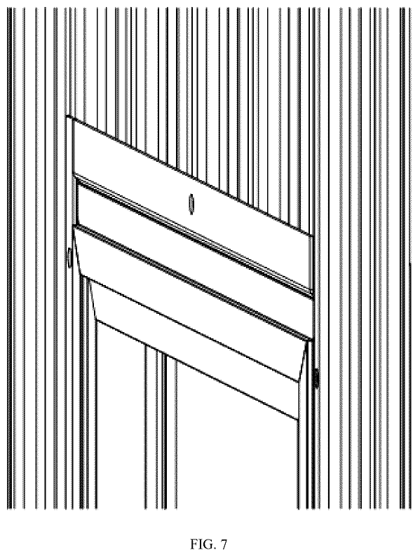

Optionally, as shown in FIG. 5, the flow guide structure includes a barrier bar 24, an end of which is installed on the wall, and the barrier bar 24 is vertical or basically vertical to an extension direction of the aluminum groove 32. The barrier bar is arranged on an upper side of a junction between the wall and the window to receive water flowing down from the wall located on an upper side of the window, and an inclined bar 25 is provided below the barrier bar 24 along an extension direction of the drainage groove, the inclined bar is arranged obliquely to the drainage groove and can guide rainwater to completely flow into the drainage groove 23, then flow to the drainage groove 23 at two sides, so that a case where the rainwater permeates the wall is reduced. In another alternative embodiment, as shown in FIG. 7, the flow guide structure includes the barrier bar 24, the barrier bar is fixedly connected with an inner wall of the drainage groove 23. Meanwhile, the barrier bar 24 extends upward out of the drainage groove 23, and the barrier bar 24 is abutted against the wall 31. Meanwhile, the barrier bar 24 covers a part of the aluminum grooves 32 of the wall 31, and rainwater flowing from the aluminum grooves 32 may contact with the barrier bar 24. In order to further slowdown water seepage, similar inclined bars can further be provided.

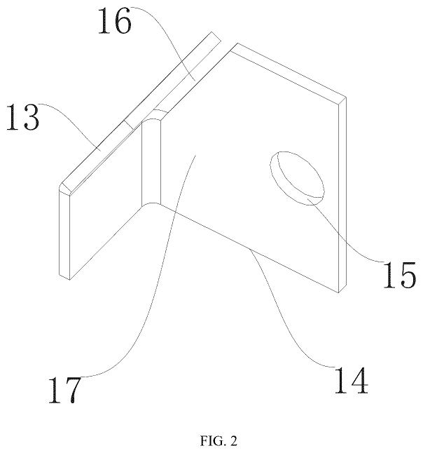

As shown in FIG. 1 and FIG. 2, the water retaining member 11 includes a main part 12. A flow guide part 13 is fixedly connected above the main part 12, and the flow guide part 13 is obliquely arranged. When the water retaining member 11 is fixedly connected with the drainage groove 23, the main part 12 is abutted against the bottom wall of the drainage groove 23, and an included angle is provided between the flow guide part 13 and the inner wall of the drainage groove 23, and the included angle is configured for guiding water flow to be discharged.

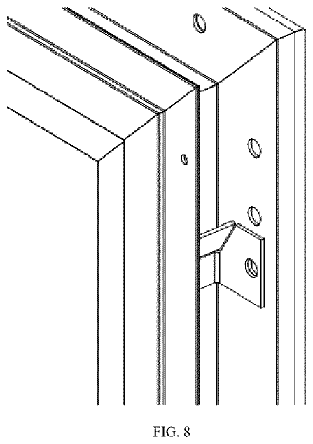

There are two water retaining members 11 in a vertical direction in the drainage groove 23 at one side, and the water retaining members 11 are symmetrically arranged up and down. In the upper water retaining member 11, as shown in FIG. 8, the flow guide part 13 is located above the water retaining member 11, and a groove is formed between the flow guide part 13 and the inner wall of the drainage groove 23. When rainwater flows downward, it may flow to the groove and then be discharged from a top of the flow guide part 13 (an inclined plane of the flow guide part 13 is opposite to the inner wall of the drainage groove, so that a triangular inner groove is formed), and the rainwater can be discharged from the flow guide part 13 in an arc line, do not contact with the window, and can be discharged more easily.

In the lower water retaining member 11, the flow guide part 13 is located below the main part 12, and the flow guide part 13 also forms an inclined plane to guide the rainwater to form arc discharging.

Further, the water retaining member 11 further includes a connecting part 14, the connecting part 14 is fixedly connected with a side wall of the main part 12. The connecting part 14 is provided with a connecting hole 15 for fixing, and the water retaining member 11 passes through the connecting hole 15 by bolts and then is fixed to the side wall of the drainage groove to realize fixing of the water retaining member.

However, the connecting part 14 is not fixedly connected with the flow guide part 13, and there is a gap 16 remained between the connecting part 14 and the flow guide part 13. For the water retaining member 11 located at an upper part of the drainage groove 23, when a water flow is too small, rainwater may accumulate in the groove between the flow guide part 13 and the inner wall of the drainage groove 23, which may easily corrode the water retaining member 11. The gap 16 between the connecting part 14 and the flow guide part 13 can drain accumulated water and prevent the water retaining member 11 from being damaged.

For the water retaining member 11 located at a lower part of the drainage groove 23, the gap 16 can better drain rainwater, and the water retaining member 11 is not easy to be corroded.

The above-described embodiments only express several implementations of the present disclosure, and their descriptions are more specific and detailed, but they cannot be constructed as limiting a scope of the present disclosure. It should be noted that, several modifications and improvements can be made by those of ordinary skill in the art without departing from the concept of the present disclosure, which belong to the protection scope of the present disclosure. Therefore, the protection scope of this disclosure shall be subjected to appended claims.

1. A water retaining window, comprising an outer window and an inner window member, wherein a drainage groove is provided between the outer window and the inner window member, a water retaining member is fixedly installed in the drainage groove at both sides, and the outer window is connected with a flow guide structure at the drainage groove at an upper side.

2. The water retaining window according to claim 1, wherein the water retaining member comprises a main part, an upper side of the main part is connected with a flow guide part which is obliquely arranged, a side wall of the main part is provided with a connecting part for fixing, and a flow guide cavity is formed among the connecting part, the flow guide part and the main part.

3. The water retaining window according to claim 1, wherein the water retaining member is respectively provided at upper and lower ends of the drainage groove, upper and lower water retaining members are oppositely arranged, opening directions of two flow guide cavities are opposite, the connecting part is fixedly connected with a side wall of the drainage groove, and the main part is abutted against an inner wall of the drainage groove.

4. The water retaining window according to claim 3, wherein the flow guide structure includes a barrier bar, the barrier bar is fixedly connected with the side wall of the drainage groove, the barrier bar extends upward out of the drainage groove, and an inclined bar is fixedly connected below the barrier bar in the drainage groove.

5. The water retaining window according to claim 4, wherein the outer window and the inner window member are located on inner and outer sides of a wall respectively.

6. The water retaining window according to claim 2, wherein a gap is remained between the flow guide part and the connection part.

7. The water retaining window according to claim 2, wherein the connecting part is provided with a through connecting hole.
